(19) United States
(12) Patent Application Publication
(10) Pub. No.: US 2015/0224032 A1
(43) Pub. Date: Aug. 13, 2015

(54) CHILD GARMENT

(71) Applicant: Melissa Dierker, Camp Lejeune, NC (US)

(72) Inventor: Melissa Dierker, Camp Lejeune, NC (US)

(21) Appl. No.: 14/179,054

(22) Filed: Feb. 12, 2014

(51) Int. Cl. A61J 17/00

(52) U.S. Cl. CPC A61J 17/00; A61J 2017/008

(57) ABSTRACT

A child's garment has a loop fastener, from which a toy tether is suspended. The tether has at least a portion thereof formed stretchable and resilient. A toy, pacifier, teething ring and the like can be secured to a distant end of the tether. The child can pull the toy and the stretchable portion stretches. When the child releases the toy by accident or intentionally, the toy does not fall to the ground but is resiliently pulled back and remains attached to the tether.

### BACKGROUND OF THE INVENTION

This invention relates to a child garment, and more particularly to a child garment having a means for detachably attaching a toy or pacifier.

It is well known that young children, in the development stage, have a tendency to drop or throw down their toys, pacifiers, and other objects. Throwing things is a skill that many young children enjoy. It takes fine motor skills to open the fingers and let go of an object and considerable hand-eye coordination to actually throw it. This means, of course, that somebody has to be on hand to retrieve the lost object and, in the case of a pacifier, to clean the object before its return.

Some manufacturers offer a pacifier suspended from a cord. The cord can be placed over the child's neck so as to make the pacifier easily reachable and prevent contamination when the child throws the pacifier down. However, such arrangement is potentially dangerous as the child may wrap the strap around the neck and suffocate.

Other devices suggest using buttons for securing a cord with a suspended toy to the child's garment. However, the use of such fastening devices presents a choking hazard should a child detach the button and inadvertently swallow it, which may lead to suffocation. The use of pins or clips is equally unacceptable for securing a toy to a young child's article of clothing.

This invention contemplates elimination of drawbacks associated with conventional toy suspension means and provision of an article of children's clothing that can detachably carry a toy or other object without the fear of the strap being wrapped around the child's neck.

### SUMMARY OF THE INVENTION

It is, therefore, an object of the present invention to provide a child's garment having a means for detachable attachment of a toy, pacifier, teething ring and the like.

It is another object of the invention to provide a child's article of clothing having a detachable means for suspending a toy or other object that can be easily removed by an adult and not readily removable by a child.

These and other objects of the invention are achieved through a provision of a child garment which has a garment portion with a loop fastener member affixed thereto. A tether member having a first non-stretchable end portion is detachably securable to the fastener member of the garment portion. The second non-stretchable end portion is detachably securable to a toy, a pacifier, a teething ring and the like.

A central stretchable resilient portion extending between the first end portion and the second end portion and integrally continuously formed therewith allows the tether member to stretch and contract when the child pulls the toy or releases the toy. The tether member and the toy can be disengaged from the garment portion to allow cleaning of the garment and the tether member, when necessary.

### BRIEF DESCRIPTION OF THE DRAWINGS

Reference will now be made to the drawings wherein like parts are designated by like numerals, and wherein

FIG. 1 is a front perspective view of the child's garment according to this invention.

FIG. 2 is a detail view of the tether member for suspending a toy of the apparatus of the present invention with knots tied at both ends.

FIG. 3 is a detail view of the tether member secured to a garment portion and carrying a toy.

FIG. 4 is a front view of the tether member of the present invention.

FIG. 5 is a detail view of the child's garment according to the present invention with the suspension means removed to show a fastener member secured to the garment portion.

FIG. 6 is a cross-sectional view taken along lines 6-6 of FIG. 2.

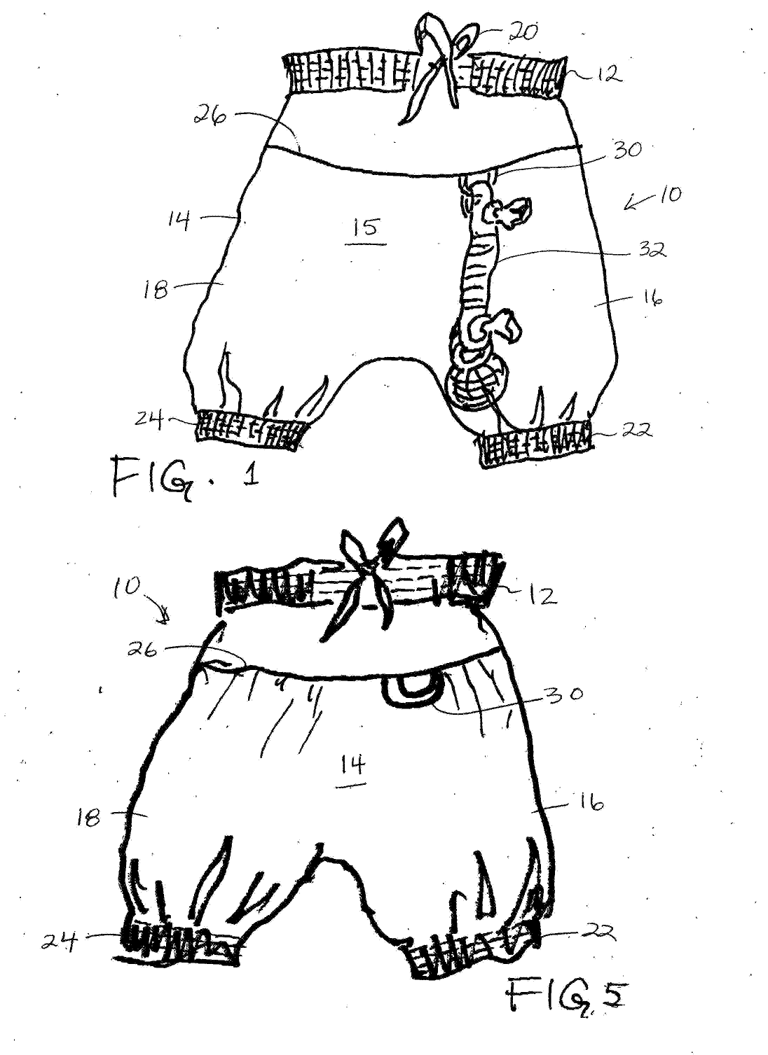

### DETAIL DESCRIPTION OF THE INVENTION

Turning now to the drawings in more detail, numeral 10 designates the child's garment according to the present invention. The garment has a garment portion 14 and a tether member 32. In the exemplary embodiment shown in the drawings the garment is shown as child's pants having a waist band 12, a front portion 15, a left leg portion 16 and a right leg portion 18.

The waist band 12 can be an elastic band, a 2″ wide band gathered by smocking and provided with a drawstring 20, or other suitable means for maintaining the pants on a child's waist. A gathered cuff 22 can be provided on the bottom of the left leg portion 16, and a similar gathered cuff 24 can be provided on the bottom of the right leg portion 18. The cuffs 22 and 24 are optional, and the leg portions 16 and 18 can be hemmed in a conventional manner.

A hip seam 26 is formed below the waist band 12 across the front portion 15. The hip seam 26 can extend only across the front portion 14 and also across the back portion of the pants 10, if desired. A fastener member 30 is permanently attached to the front portion 15. In one aspect of the invention, the fastener member 30 is a loop sewn into the hip seam 26 by stitching. The loop 30 can be formed from a non-stretchable flexible material, for instance a 2″ cotton cord. Of course, the loop 30 can be also formed from washable leather, natural or artificial fiber material, and other suitable material.

A tether member 32 is detachably engaged with the loop 30. The tether member 32 comprises an elongated strap 34, at least a portion of which has a hollow tubular configuration with an opening extending therethrough. The strap 34 has a first end 36 and a second end 38. The strap 34 can be made of a fabric material, such as cotton, rayon, nylon, silk, linen, polyester and combinations thereof. The strap can be formed from a longitudinally folded piece of material, where the long edges are joined together at a seam line 33 by means of stitching, gluing and the like. In one embodiment of the invention, an open space 35 is formed between the folded pieces of the strap.

The strap 34 comprises a central stretchable resilient portion 40 and a pair of opposite non-stretchable end portions 42, 44 integrally continuously formed with the central portion 40. An elastic band 46 is sewn into the central portion 40 and secured at opposite ends of the elastic band to the strap 34 along seam lines 43 and 45, respectively. The seams 43, 45 extend across the strap 34; the seams 43, 45 can be made by stitching, gluing, laser fusing, and the like. The elastic resilient band 46 may be made of elastic materials such as elasticized plastics, rubber, plasticized rubber, elasticized fabric materials and the like.

The longitudinal dimensions of the elastic band 46 are at least slightly smaller than the longitudinal dimensions of the central portion 40, as a result of which the central portion 40 is gathered into a plurality of small gathers, while the end portions 42, 44 are not gathered to facilitate tying knots on the end portions, as will be explained in more detail hereinafter.

To suspend a toy, pacifier or other object from the garment portion 14, a knot 48 is user-formed in the first end portion 42 a distance from the first end 36; a similar knot 50 is user-formed in the opposite end portion 44 of the strap 34 adjacent the second end 38. The user forms the knots 48 and 50 by knotting the end portions of the strap 34, before or after the user suspends the tether member 34 from the fastener loop 30.

A first slit 52 is formed in the first end portion 42 a distance from the first end 36. The first slit 52 extends through the entire thickness of the strap 34. A second slit 54 is formed in the second end portion 44 a distance from the second end 38. The slit 54 similarly extends through the entire thickness of the strap 34.

The material of the first end portion 42 and the second end portion 44 has sufficient flexibility to permit an outward flexing when the knots 48 and 50 are forced through the slits 52 and 54, respectively. By pushing the first end portion 42 through the loop 30, folding it down and then pushing the first knot 48 through the first slit 52, the strap 34 can be detachably suspended from the loop 30, which is affixed to the article of clothing such as pants.

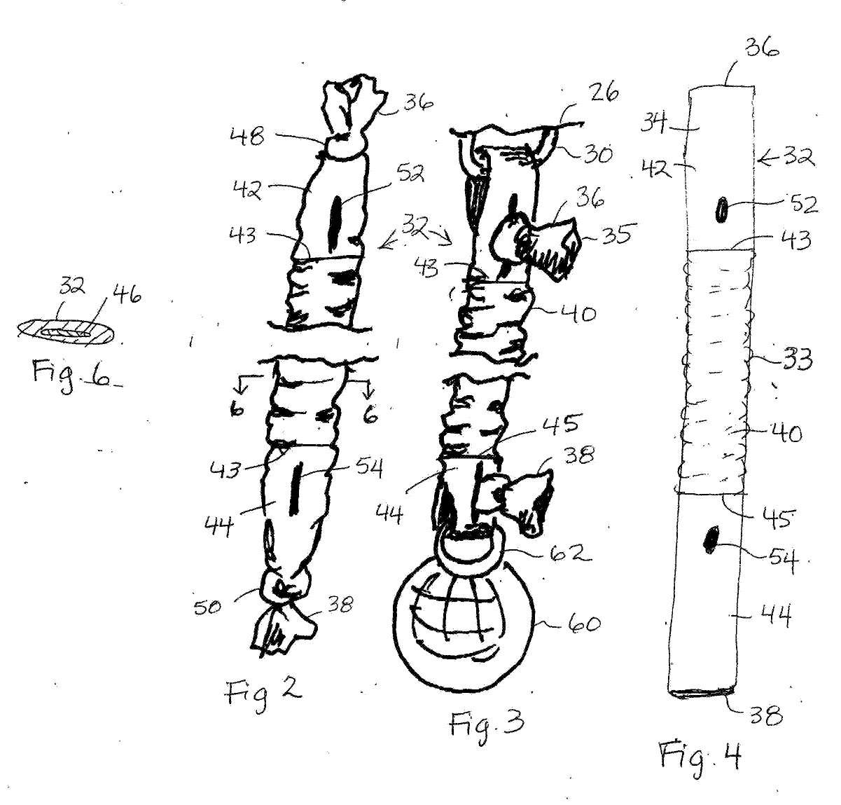

A toy, a teething ring, a nipple, or other small object 60 is detachably engaged with the second end portion 44. The exemplary illustration of FIG. 2 shows a toy 60 being a spherical object with a grasping ring 62. The second end portion 44 is threaded through the grasping ring 62, folded up, and the second knot 50 is pushed through the second slit 54 in a manner shown in FIG. 2. The knot 48 retains the strap 34 in its position on the pants, while the knot 60 retains the toy 60 suspended on the strap 34.

Thus the object, whether it is a toy, a pacifier, etc., can be readily attached or detached by an adult but cannot be separated by a small child wearing the garment 10. The child can easily pull the toy closer by stretching the central portion 40. Once released, the toy 60 will remain suspended from the garment due to the elasticity and resilience of the elastic band 46 integrated into the central portion 40 of the strap 34. One of the advantages of the invention is that a toy can be attached to a garment and used to pacify a child sitting in its high chair, in a car seat, or on a parent's lap. The garment can be safely used when the child is playing alone or in the presence of an adult. The child is unable to throw away the toy or the pacifier and thus there is no risk of the toy or pacifier becoming contaminated or the child crying over a lost toy.

When the garment needs to be washed, the strap 34 can be easily detached from the fastener loop 30 and the toy 60 can be likewise detached from the second end portion 44 of the strap 34. The strap 34 and the pants can be washed separately, and then the strap 34 can be again attached to the garment. The toy 60 can be replaced by other toys, pacifier, teething ring, or any other child-oriented object of interest to the child.

If desired, only the central portion 40 can be formed as a tubular member to accommodate the elastic band 46. The end portions 42 and 44 can be formed from a flat piece of fabric, leather, etc. and stitched to the central portion 40 along the stitch lines 43 and 45.

Many other changes and modifications can be made in the present invention without departing from the spirit thereof. I, therefore, pray that my rights to the present invention be limited only by the appended claims.

I claim:

1. A child garment, comprising:
A garment portion having a fastener member affixed thereto; and
a tether member having a first non-stretchable end portion detachably securable to the fastener member of the garment portion, a second non-stretchable end portion detachably securable to a toy, and a central stretchable resilient portion extending between the first end portion and the second end portion and integrally continuously formed therewith.

2. The garment of claim 1, wherein the central portion comprises a hollow tubular body having an opening extending therethrough.

3. The garment of claim 2, wherein an elastic band is secured in the opening of the central portion.

4. The garment of claim 3, wherein longitudinal dimensions of the elastic band is at least slightly smaller than longitudinal dimensions of the central portion.

5. The garment of claim 1, said fastener member comprising a loop member fixedly attached to a front of the garment portion.

6. The garment of claim 1, said first end portion comprising a first slit and a user-formed first knot formed a distance from the first slit, said first end portion being configured to detachably engage the fastener member, and the first knot is configured to extend through the first slit of the first end portion thereby detachably securing the tether member with the fastener member.

7. The garment of claim 1, the second end portion comprising a second slit and a second user-formed knot formed a distance from the second slit, said second end portion being configured to detachably engage a toy, and the second knot is configured to extend through the second slit of the second end portion thereby detachably securing the toy with the tether member.

8. A method of securing a toy on a child's garment, comprising the steps:
providing a garment portion having a fastener member attached thereto;
providing a tether member having a first non-stretchable end portion, a second non-stretchable end portion, and a central stretchable portion extending between the first end portion and the second end portion and integrally continuously formed therewith;
detachably securing the first end portion to the fastener member;
detachably securing the second end portion to the toy, while allowing the central portion to extend and contract when the toy is pulled or released.

9. The method of claim 8, wherein the central portion has a hollow tubular configuration, and wherein an elastic band is secured therein.

10. The method of claim 9, wherein longitudinal dimensions of the elastic band is at least slightly smaller than longitudinal dimensions of the central portion.

11. The method of claim 8, said fastener member comprising a loop member fixedly attached to a front of the garment portion.

12. The method of claim 8, said first end portion comprising a first slit formed a distance from the central portion.

13. The method of claim 12, comprising a step of forming a first knot in the first end portion.

14. The method of claim 13, comprising a step of detachably engaging the first end portion with the fastener member and then forcing the first knot through the first slit, thereby detachably securing the tether member on the garment portion.

15. The method of claim 8, said second end portion comprising a second slit formed a distance from the second portion.

16. The method of claim 15, comprising a step of forming a second knot in the second end portion.

17. The method of claim 16, comprising a step of detachably engaging the second end portion with the toy and then forcing the second knot through the second slit, thereby detachably securing the toy on the tether member.
